(19) United States
(12) Patent Application Publication
(10) Pub. No.: US 2025/0323314 A1
(43) Pub. Date: Oct. 16, 2025

(54) CATHODE LAYER AND SOLID-STATE BATTERY

(71) Applicant: TOYOTA JIDOSHA KABUSHIKI KAISHA, Toyota-shi (JP)

(72) Inventors: Masaru KUBOTA, Okazaki-shi (JP); Takuya KIMURA, Toyota-shi (JP)

(73) Assignee: TOYOTA JIDOSHA KABUSHIKI KAISHA, Toyota-shi (JP)

(21) Appl. No.: 19/033,721

(22) Filed: Jan. 22, 2025

(30) Foreign Application Priority Data
Apr. 11, 2024 (JP) 2024-063675

(51) Int. Cl. H01M 10/0562; H01M 4/02; H01M 4/36; H01M 4/525

(52) U.S. Cl. CPC H01M 10/0562; H01M 4/366; H01M 4/525; H01M 2004/021; H01M 2004/028; H01M 2300/0068

(57) ABSTRACT

A cathode layer comprising at least a cathode active material and a solid electrolyte, wherein the cathode active material is cathode active material particles, an average particle diameter of the cathode active material particles is 2.5 μm or more and 4.5 μm or less, and a normalized interface length value A (μm⁻¹) obtained by dividing a length (μm) of an interface between the cathode active material and the solid electrolyte confirmed from a SEM image of a cross section of the cathode layer by an area (μm²) of the cathode active material in SEM image is 1.15 or more.

### CROSS-REFERENCE TO RELATED APPLICATION

This application claims priority to Japanese Patent Application No. 2024-063675 filed on Apr. 11, 2024, incorporated herein by reference in its entirety.

### BACKGROUND

### 1. Technical Field

The present disclosure relates to a cathode layer and a solid-state battery.

### 2. Description of Related Art

Various types of technology have been proposed for batteries, such as disclosed in WO 2021/176759.

### SUMMARY

Even when an area ratio of a solid electrolyte at a predetermined distance from surfaces of cathode active material particles is high in a cross-sectional image of a cathode layer, resistance of the battery is high when a contact interface length between the cathode active material particles in the cathode layer and solid electrolyte particles is short.

The present disclosure has been made in view of the above circumstances, and a primary object thereof is to provide a cathode layer capable of reducing resistance of a battery.

That is to say, the present disclosure includes the following aspects.

<1> A cathode layer including at least a cathode active material and a solid electrolyte, in which
the cathode active material is cathode active material particles,
an average particle diameter of the cathode active material particles is no less than 2.5 μm and no more than 4.5 μm, and
a normalized interface length value A (μm⁻¹) that is obtained by dividing a length (μm) of an interface between the cathode active material and the solid electrolyte that is confirmed from a scanning electron microscope (SEM) image of a cross-section of the cathode layer, by an area (μm²) of the cathode active material in the SEM image, is no less than 1.15.

<2> The cathode layer according to <1>, in which the average particle diameter of the cathode active material particles is no less than 3.0 μm and no more than 4.0 μm.

<3> The cathode layer according to <1> or <2>, in which the solid electrolyte is a sulfide solid electrolyte.

<4> The cathode layer according to any one of <1> to <3>, in which the cathode active material is a lithium-ion conductive-compound-coated cathode active material in which a lithium-ion conductive compound is coated on at least part of a surface of the cathode active material.

<5> A solid-state battery, including the cathode layer according to any one of the above <1> to <4>.

The cathode layer according to the present disclosure can reduce resistance of a battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing a relationship between a normalized interface length value A and a normalized battery resistance;

FIG. 2 is a graph showing the relation between the average particle diameter of the cathode active material particles, the electron conductivity of the cathode layer, and the ion conductivity of the cathode layer; and

FIG. 3 is a graph showing the relationship between the average particle diameter of the cathode active material particles and the filling ratio of the cathode layer.

### DETAILED DESCRIPTION OF EMBODIMENTS

Hereinafter, embodiments according to the present disclosure will be described. Note that matters other than those specifically mentioned in the present specification and necessary for the implementation of the present disclosure can be understood as design matters of a person skilled in the art based on the prior art in the field. What is needed in the practice of the present disclosure is, for example, the general construction and manufacturing process of a cathode layer that does not characterize the present disclosure. The present disclosure can be carried out based on content disclosed in the present specification and common knowledge in the technical field.

In the present disclosure, the full charge state of a battery means a state where the state of charge (SOC: State of Charge) of the battery is 100%. SOC indicates a ratio of the charge capacity to the full charge capacity of the battery, and the full charge capacity is SOC 100%. SOC may be estimated, for example, from the open circuit voltage (OCV: Open Circuit Voltage) of the cell.

In the present disclosure, unless otherwise specified, the average particle diameter of the particles is a value of the median diameter (D50) which is the particle diameter at an integrated value of 50% in a volume-based particle size distribution measured by laser diffraction/scattering particle size distribution measurement.

The present disclosure provides a cathode layer including at least a cathode active material and a solid electrolyte. The cathode active material is a cathode active material particle. The average particle diameter of the cathode active material particles is 2.5 μm or more and 4.5 μm or less. a normalized interface length value A (μm⁻¹) that is obtained by dividing a length (μm) of an interface between the cathode active material and the solid electrolyte that is confirmed from a scanning electron microscope (SEM) image of a cross-section of the cathode layer, by an area (μm²) of the cathode active material in the SEM image, is no less than 1.15.

The normalized interface length value A (μm⁻¹) obtained by dividing the length (μm) of the interface between the cathode active material and the solid electrolyte, which is confirmed from SEM (scanning electron microscope) image of the cross section of the disclosed cathode layer, by the area (μm²) of the cathode active material in SEM image may be 1.15 μm⁻¹ or more. The normalized interface length value A (μm⁻¹) may be greater than or equal to 1.39 μm⁻¹. The normalized interface length value A (μm⁻¹) may be less than or equal to 1.76 μm⁻¹.

The normalized interface length value A may be controlled by at least one of the following methods.
(i) The average particle diameter of the cathode active material particles is changed
(ii) The average particle diameter of the solid electrolyte particles is changed
(iii) The volume ratio of the solid electrolyte in the cathode layer is changed
(iv) To change a coating ratio of a solid electrolyte coated with a cathode active material or a lithium-ion conductive-compound-coated cathode active material
(v) The coating method of the solid electrolyte is changed.

When the normalized interface length value A is 1.15 μm⁻¹ or more, the resistivity of the cell can be reduced. In the present disclosure, by using a combination of cathode active material particles having a predetermined average particle diameter and a predetermined solid electrolyte, it is possible to obtain a cathode layer having a contact area (interface length) between the cathode active material particles and the solid electrolyte having a predetermined size.

The cathode layer includes at least a cathode active material and a solid electrolyte, and may contain a binder, a conductive material, or the like as necessary.

The cathode layer of the present disclosure may have a solid electrolyte on at least a part of the surface of the cathode active material. The cathode layer of the present disclosure may have a solid electrolyte on the entire surface of the cathode active material. The cathode layer of the present disclosure may have a solid electrolyte on at least a part of the surface of the lithium-ion conductive-compound-coated cathode active material. The cathode layer of the present disclosure may have a solid electrolyte on the entire surface of the cathode active material coated with the lithium-ion conductive-compound-coated cathode active material.

The coating ratio of the cathode active material or the solid electrolyte coated with the lithium-ion conductive-compound-coated cathode active material is not particularly limited as long as it satisfies the normalized interface length value A defined in the present disclosure. The coverage of the solid electrolyte is, for example, 70% or more, may be 90% or more, or may be 100%. The method of coating the solid electrolyte is not particularly limited, and a conventionally known method can be appropriately employed.

Examples of the cathode active material include an oxide active material.

As an oxide active material, for example, LiNi_{0.8}Co_{0.15}Al_{0.05}O₂, LiCoO₂, LiMnO₂, LiNiO₂, LiVO₂, LiNi_{1/3}Co_{1/3}Mn_{1/3}O₂, LiMn₂O₄, Li(Ni_{0.5}Mn_{1.5})O₄, LiFePO₄, LiMnPO₄, LiNiPO₄, LiCuPO₄ and the like.

The cathode active material is cathode active material particles.

The average particle diameter of the cathode active material particles may be 2.5 μm or more and 4.5 μm or less, and may be 3.0 μm or more and 4.0 μm or less.

The cathode active material may be a lithium-ion conductive-compound-coated cathode active material in which a lithium ion conductive compound is coated on at least a part of a surface of the cathode active material.

The lithium ion conductive compound may cover at least a part of the surface of the cathode active material, or may cover the entire surface of the cathode active material.

Examples of the lithium ion conductive compound include B₂O₃, Li₂B₄O₇, LiBPO₄, Li₃PO₄, LiPO₃, LiNbO₃. The thickness of the film of the lithium-ion conductive compound is, for example, 0.1 nm or more, and may be 1 nm or more. On the other hand, the thickness of the lithium-ion conductive compound may be, for example, less than or equal to 100 nm and less than or equal to 20 nm. The coverage of the lithium ion conductive compound covering the cathode active material is not particularly limited as long as it satisfies the normalized interface length value A defined in the present disclosure. The coverage of the lithium ion conductive compound covering the cathode active material is, for example, 70% or more, may be 90% or more, or may be 100%. The method of coating the lithium ion conductive compound is not particularly limited, and a conventionally known method can be appropriately employed.

Examples of the solid electrolyte include a sulfide solid electrolyte and an oxide solid electrolyte.

Examples of the sulfide solid electrolyte include a solid electrolyte including an Li element, an M element (M is at least one of P, As, Sb, Si, Ge, Sn, B, Al, Ga, In), and an S element. The sulfide solid electrolyte may further contain at least one of an O element and a halogen element.

Examples of the sulfide solid electrolyte include Li₂S—P₂S₅, Li₂S—SiS₂, LiX—Li₂S—SiS₂, LiX—Li₂S—P₂S₅, LiX—Li₂O—Li₂S—P₂S₅, LiX—Li₂S—P₂O₅, LiX—Li₃PO₄—P₂S₅, and Li₃PS₄. Note that the description of “Li₂S—P₂S₅” means a material made of a raw material composition containing Li₂S and P₂S₅, and the same applies to other descriptions.

In addition, “X” in the above LiX represents a halogen element. Examples of the halogen element includes F element, Cl element, Br element, I element, and the like. One or more LiX may be contained in the raw material composition containing LiX. When two or more kinds of LiX are included, the mixing ratio of two or more kinds is not particularly limited. The molar ratio of each element in the sulfide solid electrolyte can be controlled by adjusting the content of each element in the raw material. In addition, the molar ratio and the composition of the respective elements in the sulfide solid electrolyte can be measured, for example, by ICP emission spectrometry.

The sulfide solid electrolyte may be sulfide glass, crystallized sulfide glass (glass ceramics), or a crystalline material obtained by solid phase reaction treatment of a raw material composition.

The crystalline state of the sulfide solid electrolyte can be confirmed, for example, by performing powder X-ray diffraction measurement using CuKα rays on the sulfide solid electrolyte.

The sulfide glass can be obtained by subjecting a raw material composition (for example, a mixture of Li₂S and P₂S₅) to amorphous processing. Examples of amorphous processing include mechanical milling.

The glass ceramics can be obtained, for example, by applying heat treatment to sulfide glass.

The heat treatment temperature may be any temperature higher than the crystallization temperature (Tc) observed by thermal analysis measurement of sulfide glass, and is normally 195° C. or higher. On the other hand, the upper limit of the heat treatment temperature is not particularly limited.

The crystallization temperature (Tc) of sulfide glass can be measured by differential thermal analysis (DTA).

The heat treatment time is not particularly limited as long as the desired crystallinity of the glass ceramic is obtained, but is, for example, in the range of 1 minute to 24 hours, and among them, in the range of 1 minute to 10 hours.

The method for heat treatment is not particularly limited, but may be, for example, a method using a firing furnace.

Examples of the oxide solid electrolyte include a material having a garnet-type crystal structure having an Li element, a La element, an A element (A is at least one of Zr, Nb, Ta, and Al), and an O element. Examples of the oxide solid electrolyte may also include Li₂O—B₂O₃—P₂O₅, Li₂O—SiO₂, Li₂O—B₂O₃, Li_{1.3}Al_{0.3}Ti_{0.7}(PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄, and Li₃₊ₓPO₄₋ₓNₓ (1≤x≤3).

The shape of the solid electrolyte may be particulate from the viewpoint of ease of handling.

The average particle diameter (D50) of the particles of the solid electrolyte is not particularly limited, but the lower limit may be 0.5 μm or more, 0.7 μm or more, the upper limit may be 3.5 μm or less, or 1.0 μm or less.

Examples of the binder include acrylonitrile butadiene rubber (ABR), polyvinylidene fluoride (PVDF), polytetrafluoroethylene (PTFE), and styrene-butadiene rubber (SBR).

Examples of the conductive material include carbon materials, metal particles, and conductive polymers. Examples of the carbon material include particulate carbon materials such as acetylene black (AB) and Ketjen black (KB); and fibrous carbon materials such as carbon fibers, carbon nanotubes (CNT), and carbon nanofibers (CNF).

The content ratio of the cathode active material in the cathode layer is not particularly limited, and may be 50.00 to 99.00 mass %, may be 72.20 mass % or more, and may be 82.04 mass % or less.

The content ratio of the solid electrolyte in the cathode layer is not particularly limited, and may be 1.00 to 30.00% by mass, may be 15.65% by mass or more, and may be 24.3% by mass or less.

The porosity of the cathode layer may be 2 to 10%. That is, the filling ratio of the cathode layer may be 90 to 98%.

The proportion of the cathode active material particles in the filling portion of the cathode layer may be 52 to 74%.

A battery of the present disclosure includes the cathode layer of the present disclosure, and usually includes a cathode including the cathode layer of the present disclosure, an electrolyte layer, and an anode.

The cathode of the present disclosure includes a cathode current collector and a cathode layer of the present disclosure formed by drying a cathode slurry coated on at least one surface of the cathode current collector.

The cathode slurry may contain the cathode active material, the solid electrolyte, the conductive material, the binder, a thickener, a solvent, and the like.

The coating method of the cathode slurry is not particularly limited, and a conventionally known method can be employed.

Examples of the thickener include polysaccharides such as carboxymethylcellulose (CMC) and methylcellulose.

Examples of the solvent include an aqueous solvent and an organic solvent. The aqueous solvent means water or a mixed solvent containing water and a polar organic solvent. For example, an appropriate solvent may be selected depending on the type of the cathode active material, the binder, and the like.

Water can be suitably used as the aqueous solvent for ease of handling. Examples of the polar organic solvent that can be used as the mixed solvent include alcohols such as methanol, ethanol, and isopropyl alcohol, ketones such as acetone, and ethers such as tetrahydrofuran. Examples of the organic solvents include 1,2,3,4-tetrahydronaphthalene, n-heptane, butyl butyrate, diisobutyl ketone, N-methyl-2-pyrrolidone (NMP), and the like.

Examples of the cathode current collector include metals such as aluminum, copper, SUS, and nickel. The thickness of the cathode current collector is, for example, 0.1 μm or more and 100 μm or less. The shape of the cathode current collector may be a sheet shape or the like.

As the electrolyte layer, an electrolyte solution or a solid electrolyte may be used as the electrolyte.

As the electrolytic solution, a conventionally known electrolytic solution used in a lithium ion secondary battery can be used.

The electrolyte layer may be a solid electrolyte layer. The solid electrolyte layer contains at least a solid electrolyte.

As the solid electrolyte to be contained in the solid electrolyte layer, a known solid electrolyte that can be used in a solid-state battery can be used as appropriate, and examples thereof include the oxide solid electrolyte and the sulfide solid electrolyte described above. In order to suppress the separation of the cathode layer and the anode layer from the solid electrolyte layer, a relatively soft sulfide solid electrolyte may be used as the solid electrolyte.

The solid electrolyte can be used singly or in combination of two or more. Further, when two or more kinds of solid electrolytes are used, two or more kinds of solid electrolytes may be mixed, or two or more layers of each solid electrolyte may be formed to form a multilayer structure.

The proportion of the solid electrolyte in the solid electrolyte layer is not particularly limited. However, for example, the proportion of the solid electrolyte in the solid electrolyte layer may be 50 mass % or more. The proportion of the solid electrolyte in the solid electrolyte layer may be in the range of 60% by mass or more and 100% by mass or less. The proportion of the solid electrolyte in the solid electrolyte layer may be in the range of 70% by mass or more and 100% by mass or less. The proportion of the solid electrolyte in the solid electrolyte layer may be 100% by mass.

The solid electrolyte layer may contain a binder from the viewpoint of exhibiting plasticity or the like. Examples of such a binder include materials exemplified as the binder used in the cathode layer described above. However, in order to facilitate achieving high output, the amount of the binder to be contained in the solid electrolyte layer may be 5% by mass or less from the viewpoint of preventing excessive aggregation of the solid electrolyte and enabling formation of a solid electrolyte layer having a solid electrolyte uniformly dispersed therein.

The thickness of the solid electrolyte layers is not particularly limited, and is usually 0.1 μm or more and 1 mm or less.

The anode includes an anode layer and an anode current collector.

The anode layer includes an anode active material, and optionally includes a conductive material, a binder, and the like.

Examples of the anode active material include a carbon active material, an oxide active material, and a metal active material. Examples of the carbon active material include mesocarbon microbeads (MCMB), highly oriented graphite (HOPG), hard carbon, and soft carbon. Examples of the oxide active material include Nb₂O₅, Li₄Ti₅O₁₂, and SiO. Examples of the metal-active material include In, Al, Si, and Sn.

Examples of the conductive material and the binder include the conductive material used for the cathode layer described above and the materials exemplified as the binder.

The material of the anode current collector may be a material that is not alloyed with Li, and examples thereof include SUS, copper, and nickel. Examples of the shape of the anode current collector include a foil shape and a plate shape. The shape of the anode current collector in plan view is not particularly limited, and examples thereof include a circular shape, an elliptical shape, a rectangular shape, and an arbitrary polygonal shape. The thickness of the anode current collector varies depending on the shape, but may be, for example, in a range of 1 μm to 50 μm or in a range of 5 μm to 20 μm.

The type of the battery is not particularly limited, and examples thereof include a lithium ion battery. The battery may be a primary battery or a secondary battery. The battery may be a liquid-based battery using an electrolyte solution as an electrolyte, or may be a solid-state battery.

In the present disclosure, a solid-state battery means a battery including a solid electrolyte. The solid-state battery may be a semi-solid-state battery that is a solid-state battery including a solid electrolyte and a liquid-based material, or may be an all-solid-state battery that is a solid-state battery that does not include a liquid-based material.

Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. Among them, it may be used as a power source for driving hybrid electric vehicle (HEV), plug-in hybrid electric vehicle (PHEV), or battery electric vehicle (BEV). Further, the battery may be used as a power source for a moving object (for example, a railway, a ship, or an aircraft) other than the vehicle, or may be used as a power source for an electric product such as an information processing apparatus.

### Examples 1 to 3 and Comparative Examples 1 to 3 Cathode Fabrication

LiNi_{0.8}Co_{0.15}Al_{0.05}O₂ particles were used as the cathode active material. The surface of the particles of the cathode active material was coated with a lithium ion conductive compound.

Particles of crystalline sulfide solid electrolytes were used as solid electrolytes. 1,2,3,4-Tetrahydronaphthalene was used as the solvent. SBR was used as a binder. VGCF was used as a conductive material. A cathode slurry was prepared by mixing a cathode active material, a solid electrolyte, a binder, and a conductive material in a solvent so that the cathode active material, the solid electrolyte, the binder, and the conductive material had the following mass composition ratio.

Mass composition ratio cathode active material:solid electrolyte:binder:conductive material=82.04:15.65:0.34:1.97

The prepared cathode slurry was coated on a cathode current collector. Thereafter, the coated cathode slurry was dried. Thus, a cathode having a cathode layer on the cathode current collector was obtained.

### Solid Electrolyte Layer Preparation

n-heptane and butyl butyrate were used as solvents. Sulfide glass solid electrolytes were used as solid electrolytes. ABR (acrylonitrile butadiene rubber) was used as the binder. The solid electrolyte and the binder were mixed in a solvent to prepare a solid electrolyte slurry.

The prepared solid electrolyte slurry was coated on a release film. Thereafter, the coated solid electrolyte slurry was dried. The release film was peeled from the dried solid electrolyte coated foil to obtain a solid electrolyte layer.

### Anode Fabrication

Diisobutyl ketone was used as the solvent. Li₄Ti₅O₁₂ was used as the anode active material. Sulfide glass solid electrolytes were used as solid electrolytes. SBR was used as a binder. Carbon nanotubes were used as conductive materials. an anode slurry was prepared by mixing an anode active material, a solid electrolyte, a binder, and a conductive material in the following mass composition ratio in a solvent.

Mass composition ratio anode active material:solid electrolyte:binder:conductive material=72.2:24.3:1.8:2.4

The prepared anode slurry was coated on an anode current collector. Thereafter, the coated anode slurry was dried. Thus, an anode having an anode layer on the anode current collector was obtained.

### Cell Fabrication

The produced cathode, the produced solid electrolyte layer, and the produced anode were arranged in this order to obtain a laminate. A cathode tab was attached to the cathode, and an anode tab was attached to the anode. Thereafter, the laminate was housed in a laminate film, and the laminate was sealed with a vacuum inside the laminate film, thereby producing a laminate cell (sometimes referred to as a cell). The cell constraining pressure was 5 MPa with respect to the electrode area.

### Method for Calculating Interface Length Between Cathode Active Material and Solid Electrolyte in Cathode Layer

First, a binarized image of the cathode active material and the solid electrolyte was prepared from the cross-sectional SEM image of the cathode layers. Binarized images were generated using image analysis software. This time, it was carried out using “ImageJ”.

Next, the area of the cathode active material in the binarized image and the contact interface length between the cathode active material and the solid electrolyte were determined by image analysis software. This time, calculation was performed using “MATLAB (registered trademark)”. Using these values, the interface length value A normalized by the following equation was calculated. The results are shown in Table 1.

Normalized interface length value A [μm⁻¹]=(contact interface length of cathode active material and solid electrolyte in analysis image [μm])/(area of cathode active material in analysis image [μm²])

Each of the cells of Examples 1 to 3 and Comparative Examples 1 to 3 has the same configuration except that the average particle diameter of the particles of the cathode active material in the cathode layer, the average particle diameter of the particles of the solid electrolyte, and the normalized interface length value A of the cathode active material and the solid electrolyte are the values shown in Table 1.

The normalized interface length value A was controlled by at least one of changing the average particle diameter of the particles of the cathode active material contained in the cathode layer and changing the average particle diameter of the particles of the solid electrolyte.

The cathode layer having a larger normalized interface length value A than the cathode layer having a smaller normalized interface length value A has a larger area of the cathode active material capable of carrying out the insertion and desorption reaction of lithium ions, which leads to a reduction in battery resistance.

### Charge/Discharge Evaluation

Charge/discharge evaluation was performed on the laminated cell thus prepared. The test is as follows. Activation, capacity measurement, and battery resistance measurement were performed at 25° C.
Activation: CCCV charge 0.333C-0.01 Ccut voltage upper limit 2.80V→CCCV discharge 0.333C-0.01 Ccut voltage lower limit 1.5V
Capacity measurement: The program is the same as the activation described above.
Battery resistance measurement: The voltage change AV value when the current value of 2.5C rate was passed at SOC20% was read, and the battery resistance was calculated from Ohm's law V=IR.

Durability tests: Cycling tests were performed at 1C rates from 1.50 to 2.80V, 60° C. After the endurance test, the capacity was measured again, and thereafter, the battery resistance after the endurance test was measured. The normalized cell resistances are shown in Table 1. The normalized battery resistance is the values of the battery resistances of Examples 1 to 3 and Comparative Examples 2 to 3 when the battery resistance of Comparative Example 1 is 1.

TABLE 1

| | Cathode | Solid | Normalized | Planned |
|---|---|---|---|---|
| | active | electrolyte | interface length | battery |
| | material D50 | D50 | value A | resistance |
| | μm | μm | μm⁻¹ | — |
| Comparative | 5.0 | 0.7 | 1.03 | 1.00 |
| Example 1 | | | | |
| Example 1 | 4.5 | 0.7 | 1.15 | 0.93 |
| Example 2 | 4.0 | 0.7 | 1.39 | 0.79 |
| Example 3 | 3.0 | 0.7 | 1.76 | 0.78 |
| Comparative | 3.0 | 3.5 | 0.70 | 1.40 |
| Example 2 | | | | |
| Comparative | 3.0 | 1.0 | 0.95 | 1.21 |
| Example 3 | | | | |

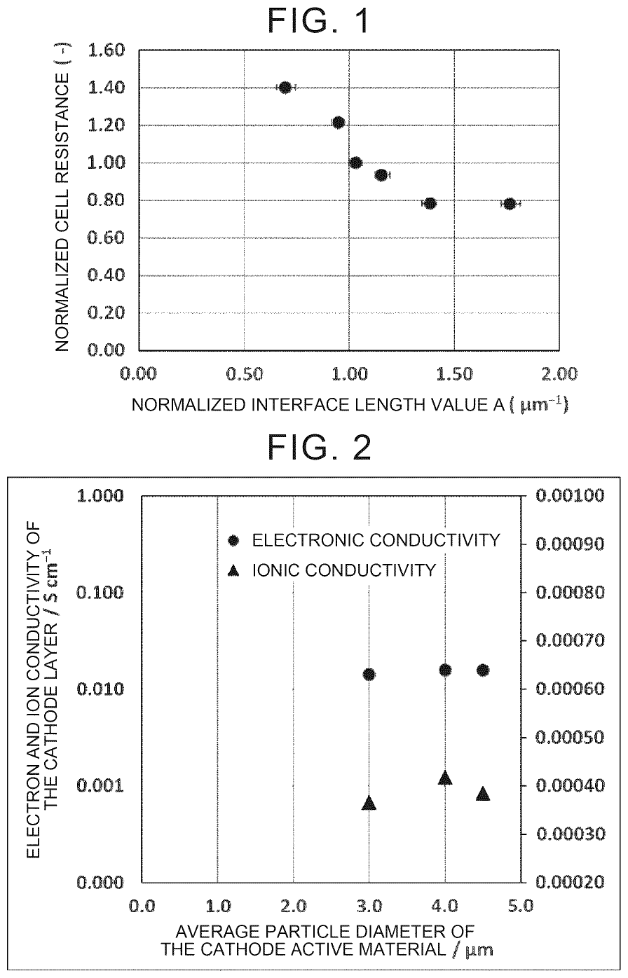

FIG. 1 is a graph showing a relationship between a normalized interface length value A and a normalized battery resistance.

As shown in FIG. 1 and Table 1, in the present disclosure, when the normalized interface length value A is 1.15 or more, the resistance of the battery can be reduced.

### Electron Conductivity Measurement of the Cathode Layer

Electron conductivity of each cathode layer was measured by the DC polarization method for each cathode layer of Examples 1 to 3. Table 2 shows the results.

### Measurement of the Ionic Conductivity of the Cathode Layer

A five-layer symmetric cell consisting of a Li metal anode layer/solid electrolyte layer/cathode layer/solid electrolyte layer/Li metal anode layer was prepared, and the ionic conductivity of the cathode layers of Examples 1 to 3 was measured by the DC polarization method for the five-layer symmetric cell. Table 2 shows the results.

### Measurement of the Filling Factor of the Cathode Layer

The density at 100% packing ratio of each cathode layer was calculated from the volume and density of each raw material contained in each cathode layer of Examples 1 to 3. The bulk density of each cathode layer was calculated by measuring the volume and mass of each cathode layer. The packing ratio of each cathode layer was calculated from the density and bulk density of each cathode layer at a packing ratio of 100%. Table 2 shows the results.

TABLE 2

| | cathode | cathode | cathode | cathode |
|---|---|---|---|---|
| | active | layer ionic | layer electron | layer filling |
| | material D50 | conductivity | conductivity | ratio |
| | μm | S/cm | S/cm | % |
| Example 1 | 4.5 | 0.00038 | 0.016 | 96.0 |
| Example 2 | 4.0 | 0.00042 | 0.016 | 96.3 |
| Example 3 | 3.0 | 0.00037 | 0.014 | 95.6 |

FIG. 2 is a graph showing the relationship between the average particle diameter of the cathode active material particles, the electron conductivity of the cathode layer, and the ion conductivity of the cathode layer.

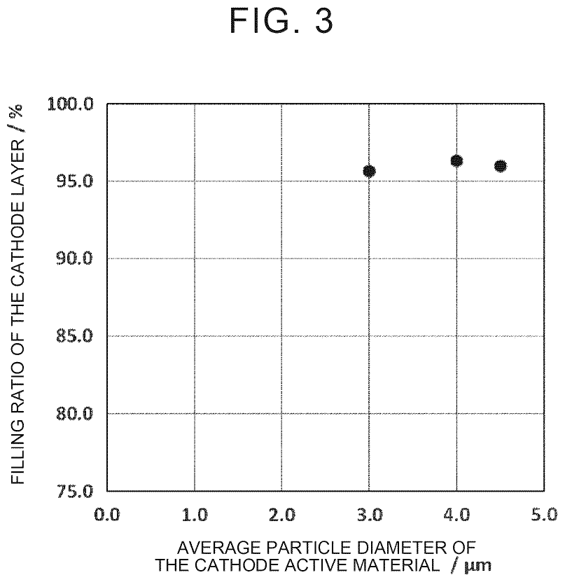

FIG. 3 is a graph showing the relationship between the average particle diameter of the cathode active material particles and the filling ratio of the cathode layer.

As shown in FIGS. 2 to 3 and 2, the electrochemical properties (electronic conductivity and ionic conductivity) and the mechanical properties (filling ratio of the cathode layer) of the cathode layer do not significantly change depending on the average particle diameter of the cathode active material particles.

What is claimed is:

1. A cathode layer including at least a cathode active material and a solid electrolyte, wherein
the cathode active material is cathode active material particles,
an average particle diameter of the cathode active material particles is no less than 2.5 μm and no more than 4.5 μm, and
a normalized interface length value A (μm⁻¹) that is obtained by dividing a length (μm) of an interface between the cathode active material and the solid electrolyte that is confirmed from a scanning electron microscope (SEM) image of a cross-section of the cathode layer, by an area (μm²) of the cathode active material in the SEM image, is no less than 1.15.

2. The cathode layer according to claim 1, wherein the average particle diameter of the cathode active material particles is no less than 3.0 μm and no more than 4.0 μm.

3. The cathode layer according to claim 1, wherein the solid electrolyte is a sulfide solid electrolyte.

4. The cathode layer according to claim 1, wherein the cathode active material is a lithium-ion conductive-compound-coated cathode active material in which a lithium-ion conductive compound is coated on at least part of a surface of the cathode active material.

5. A solid-state battery, including the cathode layer according to claim 1.
